(19) United States
(12) Patent Application Publication
(10) Pub. No.: US 2026/0158797 A1
(43) Pub. Date: Jun. 11, 2026

(54) TWO-COLOR MOLDED ARTICLE AND METHOD OF MANUFACTURING TWO-COLOR MOLDED ARTICLE

(71) Applicant: CANON KABUSHIKI KAISHA, Tokyo (JP)

(72) Inventors: DAIKI YAMAMOTO, Kanagawa (JP); YUKUO YAMAGUCHI, Tokyo (JP); RYO SATO, Kanagawa (JP)

(21) Appl. No.: 19/406,304

(22) Filed: Dec. 2, 2025

(30) Foreign Application Priority Data
Dec. 6, 2024 (JP) 2024-213830

(51) Int. Cl. B41J 2/20; B29C 45/16; B29K 21/00; B29K 23/00; B29L 31/00; B41J 2/16

(52) U.S. Cl. CPC B41J 2/20; B29C 45/1676; B41J 2/16; B41J 2/1637; B29C 2045/1678; B29K 2021/003; B29K 2023/12; B29L 2031/767

(57) ABSTRACT

A two-color molded article of the present disclosure is a two-color molded article including: a primary molded article; and a secondary molded article. The primary molded article has a ring shape into which another member is insertable. The secondary molded article has a tubular portion which supports the primary molded article. The tubular portion includes a first support portion which supports the primary molded article from a periphery of the ring shape, and a second support portion which supports the primary molded article from a direction crossing a direction in which the first support portion supports the primary molded article. A thickness of the first support portion in the direction in which the first support portion supports the primary molded article is less than a thickness of the second support portion in the direction in which the second support portion supports the primary molded article.

### BACKGROUND

### Field of the Technology

The present disclosure relates to a two-color molded article and a method of manufacturing the same.

### Description of the Related Art

Generally, two-color molded articles are formed by forming a primary molded article with a stationary mold and a movable mold, and then clamping the movable mold holding the primary molded article and a secondary stationary mold, and injecting a secondary molding resin into the secondary stationary mold.

Japanese Patent Laid-Open No. 2010-89398 discusses a configuration in which a deformation portion for absorbing a stress that acts on a primary molded article is formed to reduce deformation and distortion of the primary molded article by the injection pressure of the secondary molding.

Here, with the configuration of Japanese Patent Laid-Open No. 2010-89398, in a case where the resin for the secondary molding contacts the primary molded article, the temperature of the secondary molding resin and the like may affect the surface of the primary molded article and re-melt the surface. In this case, part of the re-melted primary molded article deforms along the flow direction of the secondary molding resin, causing deformation and distortion of the primary molded article in the same direction as the flow direction as the re-melted primary molded article cools down and cures again.

### SUMMARY

In view of this, an object of the present disclosure is to provide a two-color molded article with no or less deformation and distortion in the secondary molding.

An aspect of the present disclosure provides a two-color molded article that includes a primary molded article and a secondary molded article. The primary molded article has a ring shape into which another member is insertable. The secondary molded article has a tubular portion configured to support the primary molded article. The tubular portion includes a first support portion configured to support a periphery of the ring shape of the primary molded article, and a second support portion configured to support the primary molded article from a direction crossing a direction in which the first support portion supports the primary molded article. A thickness of the first support portion in the direction in which the first support portion supports the primary molded article is less than a thickness of the second support portion in the direction in which the second support portion supports the primary molded article.

According to the present disclosure, it is possible to provide a two-color molded article with little to no deformation and distortion in the secondary molding.

Features of the present disclosure will become apparent from the following description of embodiments with reference to the attached drawings. The following description of embodiments is described by way of example.

### BRIEF DESCRIPTION OF THE DRAWINGS

FIG. 1 is an exploded perspective view of a liquid ejection head;

FIGS. 2A and 2B are a transparent view and a cross-sectional view of a circulation unit;

FIGS. 3A and 3B are schematic views of coupling components in two-color molding;

FIG. 4 is a cross-sectional view of a coupling component during primary resin introduction according to an embodiment of the present disclosure;

FIG. 5 is a top view of the coupling component during the primary resin introduction according to an embodiment of the present disclosure;

FIG. 6 is a cross-sectional view of a body component and a coupling component during secondary resin introduction in a comparative example;

FIG. 7 is a top view of the body component and the coupling component during the secondary resin introduction in the comparative example;

FIG. 8 is a cross-sectional view of a body component and a coupling component according to an embodiment of the present disclosure;

FIG. 9 is a cross-sectional view of the body component and the coupling component during secondary resin introduction according to an embodiment of the present disclosure;

FIG. 10 is a top view of the body component and the coupling component during the secondary resin introduction according to an embodiment of the present disclosure;

FIG. 11 is a cross-sectional view of a body component and a coupling component according to a modification of the present disclosure; and

FIG. 12 is a perspective view of a modification of a circulation unit according to an embodiment of the present disclosure.

### DESCRIPTION OF THE EMBODIMENTS

An embodiment of the present disclosure will be described below with reference to drawings.

### Liquid Ejection Head

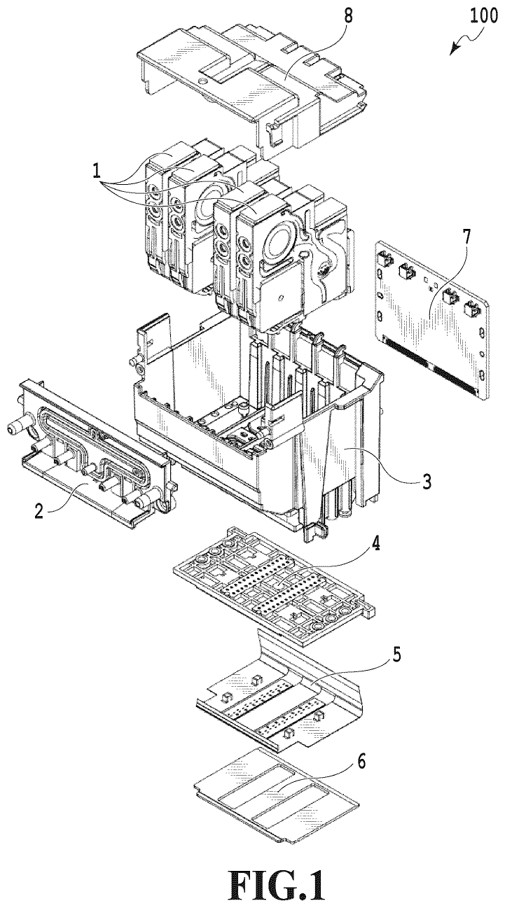

FIG. 1 is an exploded perspective view of a liquid ejection head 100. A schematic configuration of the liquid ejection head 100 in the present embodiment will be described with reference to FIG. 1.

The liquid ejection head 100 includes circulation units 1 that circulate inks therein, a main body connection member 2 to be connected to the main body of a liquid ejection apparatus, and a channel member 3 that accommodates the circulation units 1. Further, the liquid ejection head 100 includes a support member 4 disposed on the lower surface of the channel member 3, and a printing element substrate 5 that ejects the liquids through the support member 4. Furthermore, the liquid ejection head 100 includes a lower cover 6 covering the lower surface of the printing element substrate 5, an electrical wiring substrate 7 electrically connectable to the printing element substrate 5, and an upper cover 8 covering the upper surfaces of the circulation units 1.

The circulation units 1 include four circulation units for black (Bk), cyan (C), magenta (M), and yellow (Y) inks, respectively. The inks in the circulation units 1 are supplied from the main body of the liquid ejection apparatus to the printing element substrate 5 through the channel member 3. Note that the number of colors, i.e., the number of circulation units, can be set to any desired number, and the circulation units will be collectively referred to simply as “the circulation units 1” below.

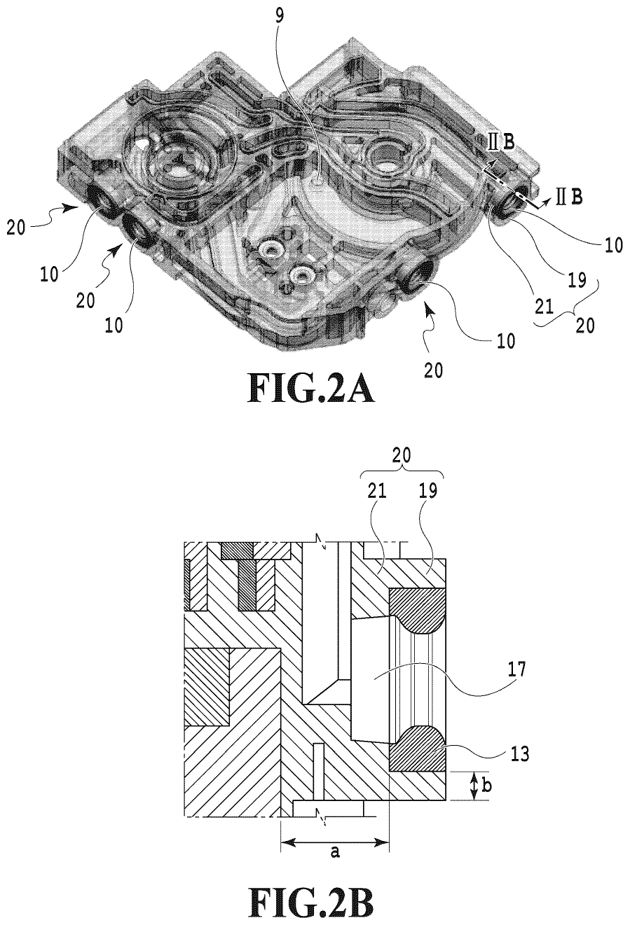

The circulation units 1 each include multiple coupling components 10 to be described later (see FIGS. 2A and 2B) and are connected to the main body connection member 2 and the channel member 3. The circulation units 1 are capable of circulating the inks supplied from the main body of the liquid ejection apparatus.

The main body connection member 2 has one side connected to the main body of the liquid ejection apparatus and the other side connected to the circulation units 1. The main body connection member 2 is connected to coupling portions 16 of the circulation units 1 to be described later. In this way, the main body connection member 2 can supply the inks supplied from the main body of the liquid ejection apparatus to the circulation units 1.

The channel member 3 accommodates the circulation units 1 and is connected thereto through the coupling portions 16 of the circulation units 1. The channel member 3 is capable of suppling the inks supplied from the circulation units 1 to the printing element substrate 5.

The support member 4 is connected to the lower surface of the channel member 3. Also, the support member 4 is also connected to the printing element substrate 5. By being connected to the channel member 3, the support member 4 can supply the inks to the printing element substrate 5. The method of connecting the support member 4 and the channel member 3 may be bonding with an adhesive agent or fixing with screws. The support member 4 and the printing element substrate 5 are bonded by an adhesive agent.

The electrical wiring substrate 7 is fixed to the surface of the channel member 3 on the opposite side from the main body connection member 2 by bonding. The electrical wiring substrate 7 is electrically connected to the circulation units 1 and the printing element substrate 5. The electrical wiring substrate 7 receives electrical signals from the main body of the liquid ejection apparatus and sends the electrical signals to the circulation units 1 and the printing element substrate 5. This enables the inks to be ejected from the printing element substrate 5.

### Circulation Units

FIG. 2A is a view illustrating tubular portions in a circulation unit 1. FIG. 2B is a cross-sectional view along the IIB-IIB line in FIG. 2A. The circulation units 1 each include a body component 9 and multiple coupling components 10. The body component 9 has tubular portions 20 that accommodate the coupling components 10, which have a ring shape. Each tubular portion 20 has a first support portion 19 that supports a first molded article 13 from a periphery of its ring shape, and a second support portion 21 that supports the first molded article 13 from the direction in which the liquid flows (the left side in FIG. 2B). By inserting connection members of the main body connection member 2 (see FIG. 1) and the channel member 3 into the tubular portions 20, ink supply channels connecting the main body connection member 2 and the channel member 3 are formed. As will be described later in detail, in the present embodiment, a thickness b of the first support portion 19 in a direction perpendicular to the ink flow direction, specifically, the direction of supporting a primary molded article, is set to be less than a thickness a of the second support portion in the ink flow direction. The coupling components 10 may be made of a material with high elasticity, in order to prevent ink leakage. For example, the coupling components 10 may be made of an injection-moldable elastic material, such as a thermoplastic elastomer. This makes it possible to omit fastening members, such as screws, for connecting the circulation units 1 and the main body connection member 2 to each other and downsize the liquid ejection head.

The tubular portions 20 may be configured to incorporate an O-ring as the coupling component 10 in an opening in the body component 9, for example. However, the configuration that incorporates an O-ring in the body component 9 requires an apparatus to insert the O-ring, and there is a possibility of inclusion of foreign substances at the time of insertion and a deterioration in sealing performance due to the foreign substances. For this reason, in the present disclosure, the body component 9 and the coupling components 10 are formed by two-color molding to solve the above issue.

### Coupling Components

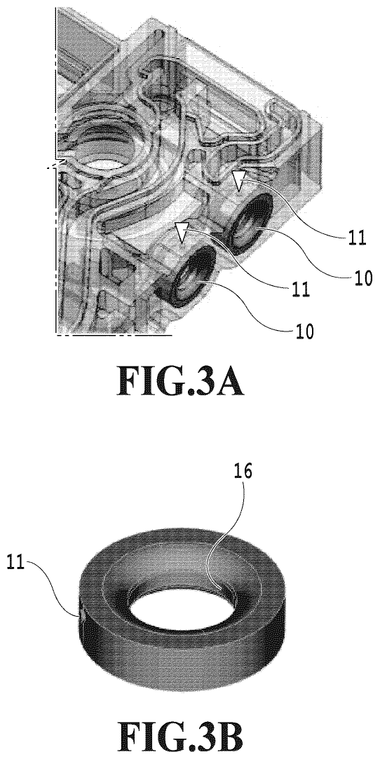

FIG. 3A is a schematic view of coupling components in the two-color molding. In a case of forming the coupling components 10, a resin is introduced from gates 11 in the mold to form ring-shaped coupling components 10, as illustrated in FIGS. 3A and 3B. At that time, the resin is filled from the inner peripheral side of the ring shape toward the outer peripheral side.

Generally, a slight filling failure called a weld may appear at the last portion where the resin is filled. If this weld appears on the inner peripheral side of the ring shape, there will be a possibility that coupling the coupling portion 16 and another member to each other may end up forming a gap therebetween. Consequently, the sealing performance may be deteriorated at the coupling component 10, which can be a cause of leakage. However, the configuration of the present disclosure is such that, as illustrated in FIG. 3B, the last portion where the resin is filled is the outer peripheral side of the ring shape, and a weld is unlikely to form on the inner peripheral side of the coupling component 10. Thus, the coupling components 10 of the present disclosure can maintain sealing performance and eliminate or reduce the concern of leakage.

In the configuration of the present disclosure, the coupling components 10 are located inside the body component 9 at the tubular portions 20. For this reason, the coupling components 10 are formed in primary molding and the body component 9 are formed in secondary molding. In a case of forming the body component 9 in the primary molding and forming the coupling components 10 in the secondary molding, it is necessary to provide gates through which to introduce the resin to form the coupling components 10 inside the body component 9. In this case, a gate is provided on the inner peripheral side of each ring shape that will be a coupling component 10, and the resin is filled from the outer peripheral side of the ring shape toward the inner peripheral side. As a result, a weld may form on the inner peripheral side of the coupling portion 16, deteriorating the sealing performance and increasing the likelihood of ink leakage.

In the present disclosure, a thermoplastic elastomer can be used for the coupling components 10, and a variety of resin materials, such as polypropylene, can be used for the body component 9. In a case where the primary molding is performed using a primary resin (thermoplastic elastomer) and then the secondary molding is performed using a secondary resin (such as polypropylene) and the coupling components 10 obtained as the primary molded articles contact the secondary resin, the coupling components 10 get strongly bonded through compatibilization by the heat. The higher the melting temperature of the body component 9 is than the melting temperature of the resin material of the coupling components 10, the stronger the bonding between the coupling components 10 and the body component 9 becomes. On the other hand, in a case where the body component 9 is formed in the primary molding and then the coupling components 10 are formed in the secondary molding, the body component 9 has already cooled down to some extent and its surface has become smooth. Accordingly, the strength of bonding to the coupling components 10 is weak. For this reason, in the present disclosure, a two-color molded article is obtained by forming the coupling components in the primary molding and forming the body component in the secondary molding.

### Manufacturing by Two-Color Molding

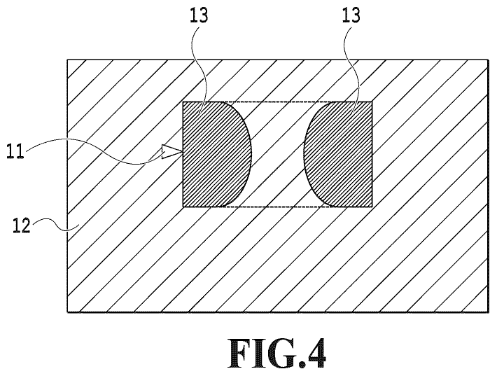

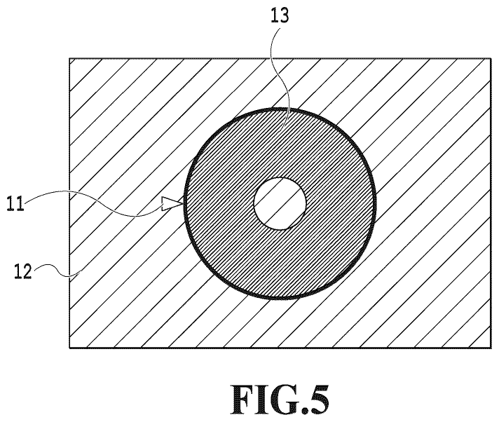

FIG. 4 is a cross-sectional view of a coupling component 10 formed in the primary molding. FIG. 5 is a top view of the coupling component 10 formed in the primary molding. In a mold 12, the gates 11 for introducing the primary resin and ring-shaped cavity for forming the coupling components 10, or the first molded articles 13, are formed. As the primary resin is introduced into the gate 11, the primary resin is filled into each ring shape from its inner peripheral side toward its outer peripheral side. Then, as the primary resin continues being filled, the primary resin is filled up to the outer peripheral side of the ring shape. As a result, the coupling components 10, or the first molded articles 13, are formed. After the first molded articles 13 are formed, as described above, the secondary resin is introduced to form a secondary molded article, which will be the body component 9.

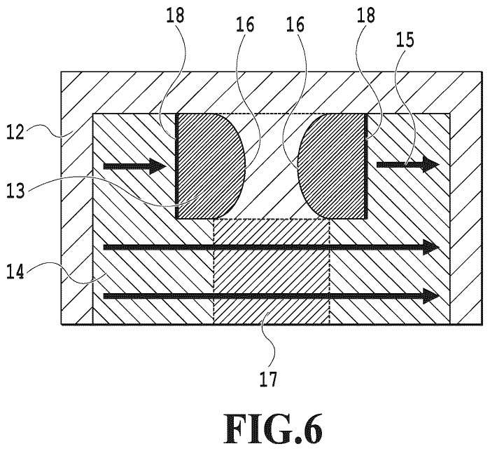

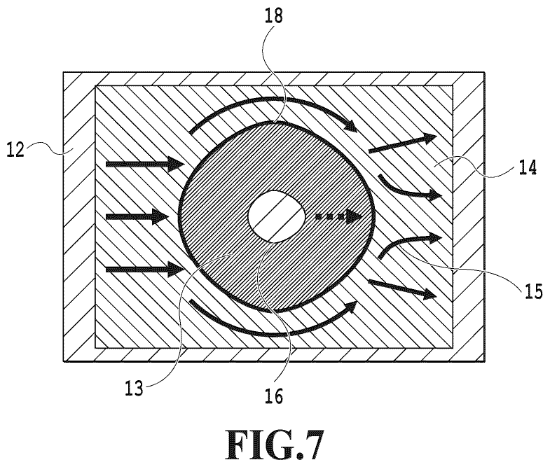

FIGS. 6 and 7 are views illustrating a comparative example of the present embodiment during the secondary molding. FIG. 6 is a cross-sectional view of a second molded article 14, which will be the body component 9, and a first molded article 13, which will be a coupling component 10, during the secondary resin introduction in the comparative example. FIG. 7 is a top view of the second molded article 14, which will be the body component 9, and the first molded article 13, which will be a coupling component 10, during the secondary resin introduction in the comparative example. Note that the gate through which to introduce the secondary resin is omitted in the figures.

The comparative example represents a state where the secondary resin is introduced from left to right along a flow direction 15 after the primary resin introduction illustrated in FIGS. 4 and 5. In the comparative example, the secondary resin is introduced along the flow direction 15 substantially at the same pressure into the portions where the primary molded articles are located and the portions where the primary molded article are not located. The outer peripheral surface of each first molded article 13 serves as a joining surface 18 to be joined to the second molded article 14. As illustrated in FIG. 7, as the secondary resin is introduced into the mold 12, the secondary resin comes into contact with the joining surfaces 18 of the first molded articles 13 and flows around their outer peripheries to fill the inside of the mold 12. Here, as the heated secondary resin is introduced, the secondary resin contacts the joining surfaces 18 of the first molded articles 13, and the first molded articles 13 locally re-melts and deforms at around the joining surfaces 18. Then, as the secondary resin solidifies over time, the re-melted and deformed first molded articles 13 and the secondary resin bond to each other and mold into a single integrated piece. When the first molded articles 13 re-melt, the first molded articles 13 soften and cannot maintain the ring shape. The flow direction 15 affects the shape of the softened first molded articles 13. Due to the softened first molded articles 13 failing to maintain the ring shape, deformed first molded articles 13 are formed, which may deteriorate the sealing performance.

To address this, in the present embodiment, the secondary resin is kept from being introduced onto the side surfaces of the first molded articles 13.

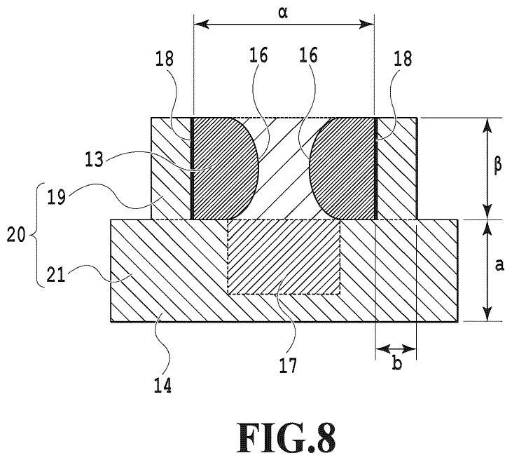

FIG. 8 is a cross-sectional view illustrating the second molded article 14 and the first molded article 13 at a tubular portion 20 according to the present embodiment. Each first molded article 13 includes an undercut portion 16 and a joining surface 18. The undercut portion 16 is the entirety of the curved shape of the first molded article 13. In a case where the circulation unit 1 is connected to the main body connection member 2 or the channel member 3, the tip of the curved portion gets compressed, thereby exhibiting a sealing function.

At each tubular portion 20, the inside of the undercut portion 16 is connected to a functional portion 17, which is an opening formed for the first molded article 13, to serve as an ink channel. Also, the first support portion 19 abuts the joining surface 18 on the side of the first molded article 13, and supports the first molded article from a periphery of the ring shape. The second support portion 21 abuts the bottom surface of the first molded article 13, and supports the first molded article from a direction crossing the support direction of the first support portion 19. In the present embodiment, the thickness b of the first support portion 19 in a direction perpendicular to the ink flow direction, i.e., the direction of supporting the primary molded article, is set to be less than the thickness a of the second support portion in the ink flow direction. The thickness b may be ⅔ of the thickness a or less. Also, a diameter α of the first molded article 13 is greater than a length β of the first molded article 13 in the direction in which the hollow region of the ring extends. This reduces the flow velocity at which the secondary resin is introduced onto the side surface of the first molded article 13, as will be described later.

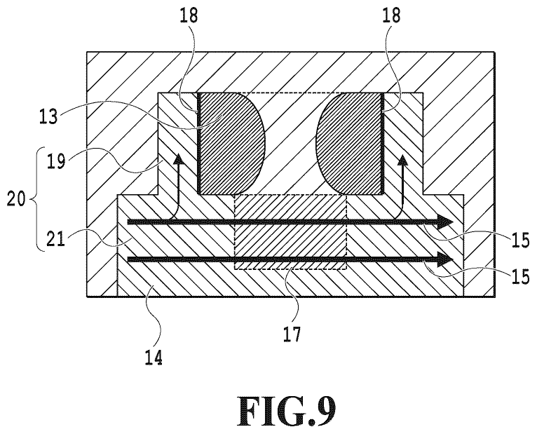

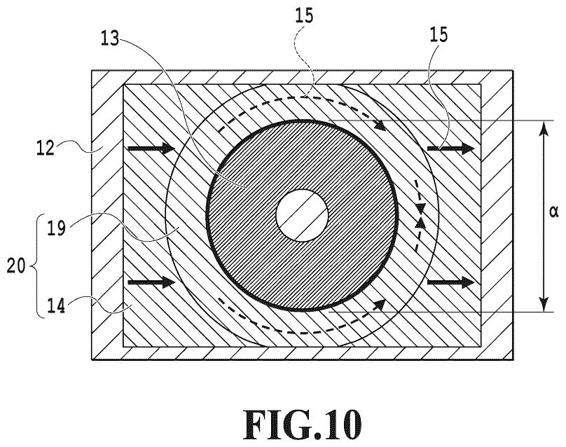

FIGS. 9 and 10 illustrate a configuration during the secondary resin introduction after the primary resin introduction in the present embodiment. In FIGS. 9 and 10, the secondary resin is introduced from left to right along the flow direction 15. In the comparative example described with reference to FIGS. 6 and 7, the secondary resin flows perpendicularly to the joining surface 18 of each first molded article 13 and is affected by that pressure. On the other hand, in the present embodiment, the flow of the secondary molding resin from left to right is limited within the region of the second support portion 21, and the first support portion 19 is formed by a flow in the direction parallel to the joining surface 18. Generally, in injection molding, thick portions tend to be filled first. Hence, the region around the joining surface 18 of each first molded article 13 is a terminal for the flow of the secondary resin. Thus, according to the present embodiment, the secondary resin is not likely to flow perpendicularly to the joining surface 18 of each first molded article 13, as described in the comparative example. This can reduce the effect of the flow of the secondary resin on the re-melted resin in the first molded article 13 and prevent or reduce the deformation of the first molded article 13. Accordingly, a coupling portion with sealing performance can be formed.

Note that the smaller a width b of the first support portion 19, which contacts the joining surface 18, within such an extent as not to impair its function of supporting the first molded article 13, the more the introduction velocity of the secondary resin can be lowered.

### Modification

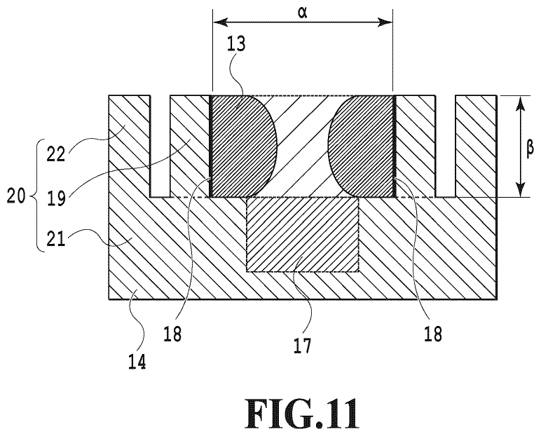

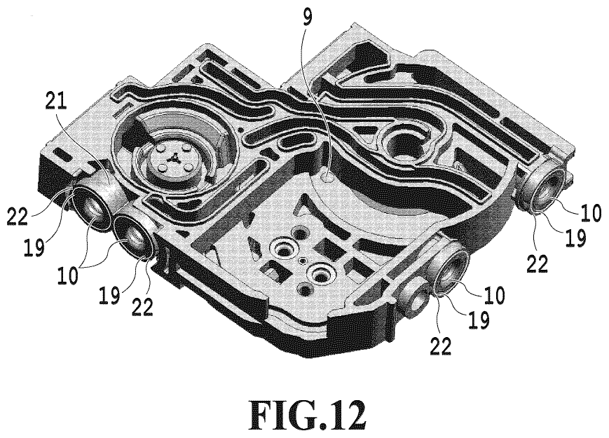

FIG. 11 is a cross-sectional view of a modification of a tubular portion 20 according to the present embodiment. FIG. 12 is a perspective view of a circulation unit 1 formed according to the present modification. As compared to FIG. 8, the shape may be such that a third support portion 22 is further provided around the outer periphery of the first support portion 19 fused to the first molded article 13 at the joining surface 18. This can further lower the flow velocity of the secondary resin when it is introduced.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2024-213830, filed Dec. 6, 2024 which is hereby incorporated by reference herein in its entirety.

What is claimed is:

1. A two-color molded article comprising:
a primary molded article; and
a secondary molded article, wherein:
the primary molded article has a ring shape into which another member is insertable,
the secondary molded article has a tubular portion configured to support the primary molded article,
the tubular portion includes:
a first support portion configured to support a periphery of the ring shape of the primary molded article, and
a second support portion configured to support the primary molded article from a direction crossing a direction in which the first support portion supports the primary molded article, and
a thickness of the first support portion in the direction in which the first support portion supports the primary molded article is less than a thickness of the second support portion in the direction in which the second support portion supports the primary molded article.

2. The two-color molded article according to claim 1, wherein the thickness of the first support portion in the direction in which the first support portion supports the primary molded article is less than or equal to ⅔ of the thickness of the second support portion in the direction in which the second support portion supports the primary molded article.

3. The two-color molded article according to claim 1, wherein an entirety of a curved shape of the ring shape of the primary molded article is an undercut portion.

4. The two-color molded article according to claim 1, wherein the primary molded article and the secondary molded article are formed from different materials.

5. The two-color molded article according to claim 4, wherein a melting temperature of the material of the secondary molded article is greater than or equal to a melting temperature of the material of the primary molded article.

6. The two-color molded article according to claim 1, wherein the primary molded article is formed of a thermoplastic elastomer.

7. The two-color molded article according to claim 1, wherein the secondary molded article is formed of polypropylene.

8. The two-color molded article according to claim 1, wherein the two-color molded article is used for a circulation unit of a liquid ejection head.

9. The two-color molded article according to claim 8, wherein:
the tubular portion is configured to function as a path through which liquid is supplied to the circulation unit, and
the primary molded article is configured to prevent leakage of the liquid.

10. The two-color molded article according to claim 1, wherein a diameter of the ring shape of the primary molded article is greater than a length of the first support portion in a direction in which a hollow region in the first support portion extends.

11. The two-color molded article according to claim 1, wherein the two-color molded article includes a plurality of the primary molded articles.

12. A method of manufacturing a two-color molded article, the method comprising:
introducing a primary resin into a mold to form a primary molded article having a ring shape; and
introducing a secondary resin different from the primary resin into the mold to form a secondary molded article having a tubular portion that is joined to an outer periphery of the ring shape of the primary molded article and is configured to support the primary molded article, wherein:
the tubular portion includes:
a first support portion configured to support the primary molded article, and
a second support portion configured to support the primary molded article from a direction crossing a direction in which the first support portion supports the primary molded article, and
a thickness of the first support portion in the direction in which the first support portion supports the primary molded article is less than a thickness of the second support portion in the direction in which the second support portion supports the primary molded article.

13. The method of manufacturing a two-color molded article according to claim 12, wherein the support by the first support portion is from a periphery of the ring shape of the primary molded article.

14. A two-color molded article comprising:
a primary molded article; and
a secondary molded article having a tubular portion configured to support the primary molded article, the tubular portion including:
a first support portion configured to support the primary molded article in a first direction, and
a second support portion configured to support the primary molded article a second direction crossing the first direction.

15. The two-color molded article according to claim 14, wherein a thickness of the first support portion in the first direction is less than a thickness of the second support portion in the second direction.

16. The two-color molded article according to claim 14, wherein the primary molded article has a ring shape into which another member is insertable.

17. The two-color molded article according to claim 16, wherein the support by the first support portion is applied to a periphery of the ring shape of the primary molded article first support portion.
